(19) United States
(12) Patent Application Publication
(10) Pub. No.: US 2024/0089943 A1
(43) Pub. Date: Mar. 14, 2024

(54) METHOD AND USER EQUIPMENT FOR BEAM OPERATION

(71) Applicant: FG Innovation Company Limited, Tuen Mun (HK)

(72) Inventors: CHIA-HAO YU, Taipei (TW); JIA-HONG LIOU, Taipei (TW); CHIA-HUNG LIN, Taipei (TW)

(73) Assignee: FG Innovation Company Limited, Tuen Mun (HK)

(21) Appl. No.: 18/272,721

(22) PCT Filed: Jan. 12, 2022
(86) PCT No.: PCT/CN2022/071666

§ 371 Date: Jul. 17, 2023

Related U.S. Application Data
(60) Provisional application No. 63/138,756, filed on Jan. 18, 2021.
(60) Provisional application No. 63/138,164, filed on Jan. 15, 2021.

(51) Int. Cl. H04W 72/044; H04L 1/1829; H04W 72/232

(52) U.S. Cl. CPC H04W 72/046; H04L 1/1854; H04W 72/232

(57) ABSTRACT

A method performed by a user equipment for a beam operation is provided. The method includes: receiving an RRC configuration for configuring a set of joint TCI states; receiving, from the BS, a MAC CE for activating a subset of joint TCI states in the set of joint TCI states, the MAC CE is used to map the subset of joint TCI states to codepoints of a TCI field in DCI; receiving the DCI indicating a joint TCI state included in the subset of joint TCI states activated by the MAC CE; determining whether the DCI includes a DL assignment; transmitting, in response to reception of the DCI, first HARQ-ACK information in a case that the DCI does not include the DL assignment; and transmitting, in response to the reception of the DCI and reception of a PDSCH, second HARQ-ACK information in a case that the DCI includes the DL assignment.

### CROSS-REFERENCE TO RELATED APPLICATION(S)

The present disclosure is a National Stage Application of International Patent Application Serial No. PCT/CN2022/071666, filed on Jan. 12, 2022, which claims the benefit of and priority to U.S. Provisional Patent Application Ser. No. 63/138,164, filed on Jan. 15, 2021, and U.S. Provisional Patent Application Ser. No. 63/138,756, filed on Jan. 18, 2021, the contents of all which are hereby incorporated herein fully by reference into the present disclosure for all purposes.

### FIELD

The present disclosure is related to wireless communication, and more particularly, to a method and a user equipment (UE) for a beam operation in the next generation wireless communication networks.

### BACKGROUND

Various efforts have been made to improve different aspects of wireless communication for cellular wireless communication systems, such as the fifth-generation (5G) New Radio (NR), by improving data rate, latency, reliability, and mobility. The 5G NR system is designed to provide flexibility and configurability to optimize the network services and types accommodating various use cases, such as enhanced Mobile Broadband (eMBB), massive Machine-Type Communication (mMTC), and Ultra-Reliable and Low-Latency Communication (URLLC). However, as the demand for radio access continues to grow, there exists a need for further improvements in the art.

### SUMMARY

The present disclosure is related to a method and a user equipment for a beam operation in the next generation wireless communication networks.

In a first aspect of the present disclosure, a method performed by a user equipment (UE) for a beam operation is provided. The method includes: receiving, a radio resource control (RRC) configuration for configuring at least one of a first set of first TCI states, a second set of second TCI states and a third set of third TCI states; receiving, a medium access control (MAC) control element (CE) for activating a first TCI state combination or a second TCI state combination, wherein the first TCI state combination includes at least one of the first TCI states, and the second TCI state combination includes at least one of the second TCI states and the third TCI states; mapping, based on the first TCI state combination or the second TCI state combination activated by the MAC CE, the first TCI state combination or the second TCI state combination to codepoints of a TCI field in downlink control information (DCI); receiving, the DCI indicating the at least one of the first TCI states, the second TCI states and the third TCI states included in the first TCI state combination or the second TCI state combination activated by the MAC CE, the DCI including a scheduling field indicating scheduling information for a physical downlink shared channel (PDSCH); transmitting, in response to the reception of the DCI, a first HARQ-ACK bit; transmitting, after determining that a bit value in the scheduling field is valid for scheduling the PDSCH, a second HARQ-ACK bit; and applying, after transmitting the first HARQ-ACK bit, the at least one of the first TCI states, the second TCI states and the third TCI states indicated by the DCI for transmission or reception.

In an implementation of the first aspect of the present disclosure, the bit value in the scheduling field is invalid for scheduling the PDSCH.

In an implementation of the first aspect of the present disclosure, each bit in at least one field in the DCI is set to “0” or “1”, and the at least one field is different from the TCI field and the scheduling field.

In an implementation of the first aspect of the present disclosure, the method further includes: applying, after determining that the DCI format indicates the first TCI states, receiver (RX) parameters for receiving one or more configured downlink (DL) transmissions and transmitter (TX) parameters for transmitting one or more configured uplink (UL) transmissions, wherein the first TCI states include the RX parameters and the TX parameters.

In an implementation of the first aspect of the present disclosure, the method further includes: applying, after determining that the DCI format indicates the second TCI states, transmitter (TX) parameters for transmitting one or more configured uplink (UL) transmissions, wherein the second TCI states include the TX parameters.

In an implementation of the first aspect of the present disclosure, the method further includes: applying, after determining that the DCI format indicates the third TCI states, receiver (RX) parameters for receiving one or more configured downlink (DL) transmissions, wherein the third TCI states include the RX parameters.

In an implementation of the first aspect of the present disclosure, the first TCI states are referred to as joint TCI states.

In an implementation of the first aspect of the present disclosure, the second TCI states are referred to as uplink (UL)-only TCI states.

In an implementation of the first aspect of the present disclosure, the third TCI states are referred to as downlink (DL)-only TCI states.

In a second aspect of the present disclosure, a UE for a beam operation is provided. The UE includes a processor; and a memory coupled to the processor. The memory stores a computer-executable program that when executed by the processor, causes the processor to: receive an RRC configuration for configuring at least one of a first set of first TCI states, a second set of second TCI states and a third set of third TCI states; receive a MAC CE for activating a first TCI state combination or a second TCI state combination, wherein the first TCI state combination includes the first TCI states, and the second TCI state combination includes at least one of the second TCI states and the third TCI states; map, based on the first TCI state combination or the second TCI state combination activated by the MAC CE, the first TCI state combination or the second TCI state combination to codepoints of a TCI field in DCI; receive, the DCI for indicating the at least one of the first TCI states, the second TCI states and the third TCI states included in the first TCI state combination or the second TCI state combination activated by the MAC CE, the DCI including a scheduling field for indicating scheduling information for a PDSCH; transmit, in response to the reception of the DCI, a first HARQ-ACK bit; transmit, after determining that a bit value in the scheduling field is valid for scheduling the PDSCH, a second HARQ-ACK bit; and apply, after transmitting the first HARQ-ACK bit, the at least one of the first TCI states, the second TCI states and the third TCI states indicated by the DCI for transmission or reception.

In a third aspect of the present disclosure, a method performed by a user equipment (UE) for a beam operation is provided. The method includes: receiving, from a base station (BS), a radio resource control (RRC) configuration for configuring a set of joint transmission configuration indication (TCI) states; receiving, from the BS, a medium access control (MAC) control element (CE) for activating a subset of joint TCI states in the set of joint TCI states, wherein the MAC CE is used to map the subset of joint TCI states to codepoints of a TCI field in downlink control information (DCI); receiving, from the BS, the DCI indicating a joint TCI state included in the subset of joint TCI states activated by the MAC CE; determining whether the DCI includes a downlink (DL) assignment; transmitting, in response to reception of the DCI, first hybrid automatic repeat request-acknowledgement (HARQ-ACK) information in a case that the DCI does not include the DL assignment; and transmitting, in response to the reception of the DCI and reception of a physical downlink shared channel (PDSCH), second HARQ-ACK information in a case that the DCI includes the DL assignment.

In an implementation of the third aspect of the present disclosure, in a case that the DCI does not include the DL assignment, a bit value corresponding to a redundancy version (RV) field included in the DCI is set to a specific value.

In an implementation of the third aspect of the present disclosure, in a case that the DCI does not include the DL assignment, a bit value corresponding to a modulation and coding scheme (MCS) field included in the DCI is set to a specific value.

In an implementation of the third aspect of the present disclosure, in a case that the DCI does not include the DL assignment, a bit value corresponding to the frequency domain resource assignment (FDRA) field is set to a specific value.

In a fourth aspect of the present disclosure, a UE for a beam operation is provided. The UE includes one or more processors; and at least one memory coupled to the one or more processors, wherein the at least one memory stores one or more computer-executable instructions that, when executed by the one or more processors, cause the UE to: receive, from a base station (BS), a radio resource control (RRC) configuration for configuring a set of joint transmission configuration indication (TCI) states; receive, from the BS, a medium access control (MAC) control element (CE) for activating a subset of joint TCI states in the set of joint TCI states, wherein the MAC CE is used to map the subset of joint TCI states to codepoints of a TCI field in downlink control information (DCI); receive, from the BS, the DCI indicating a joint TCI state included in the subset of joint TCI states activated by the MAC CE; determine whether the DCI includes a downlink (DL) assignment; transmit, in response to reception of the DCI, first hybrid automatic repeat request-acknowledgement (HARQ-ACK) information in a case that the DCI does not include the DL assignment; and transmit, in response to the reception of the DCI and reception of a physical downlink shared channel (PDSCH), second HARQ-ACK information in a case that the DCI includes the DL assignment.

In a fifth aspect of the present disclosure, a base station (BS) for a beam operation is provided. The UE includes one or more processors; and at least one memory coupled to the one or more processors, wherein the at least one memory stores one or more computer-executable instructions that, when executed by the one or more processors, cause the BS to: transmit, to a user equipment (UE), a radio resource control (RRC) configuration for configuring a set of joint transmission configuration indication (TCI) states; transmit, to the UE, a medium access control (MAC) control element (CE) for activating a subset of joint TCI states in the set of joint TCI states, wherein the MAC CE is used to map the subset of joint TCI states to codepoints of a TCI field in downlink control information (DCI); transmit, to the UE, the DCI for indicating a joint TCI state included in the subset of joint TCI states activated by the MAC CE; receive, in response to transmission of the DCI, first hybrid automatic repeat request-acknowledgement (HARQ-ACK) information in a case that the DCI does not include the DL assignment; and receive, in response to the transmission of the DCI and transmission of a physical downlink shared channel (PDSCH), second HARQ-ACK information in a case that the DCI includes the DL assignment.

### BRIEF DESCRIPTION OF THE DRAWINGS

Aspects of the disclosure are best understood from the following detailed disclosure when read with the accompanying drawings. Various features are not drawn to scale. Dimensions of various features may be arbitrarily increased or reduced for clarity of discussion.

FIG. 1 is a schematic diagram illustrating a MAC CE format with a fixed size of 16 bits that is used for activating a TCI state for a CORESET, according to an example implementation of the present disclosure.

FIG. 2 is a schematic diagram illustrating an association of one TCI codepoint with two TCI states, according to an example implementation of the present disclosure.

FIG. 3 is a flowchart illustrating a method performed by a UE for a beam operation, according to an example implementation of the present disclosure.

FIG. 4 is a block diagram illustrating a node for wireless communication, according to an example implementation of the present disclosure.

### DESCRIPTION

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art. Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may be different in other respects and may not be narrowly confined to what is illustrated in the drawings.

The phrases “in one implementation,” or “in some implementations,” may each refer to one or more of the same or different implementations. The term “coupled” is defined as connected whether directly or indirectly via intervening components and is not necessarily limited to physical connections. The term “comprising” means “including, but not necessarily limited to” and specifically indicates open-ended inclusion or membership in the so-disclosed combination, group, series or equivalent. The expression “at least one of A, B and C” or “at least one of the following: A, B and C” means “only A, or only B, or only C, or any combination of A, B and C.”

For the purposes of explanation and non-limitation, specific details such as functional entities, techniques, protocols, and standards are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software or a combination of software and hardware. Disclosed functions may correspond to modules which may be software, hardware, firmware, or any combination thereof. A software implementation may include computer executable instructions stored on a computer readable medium such as memory or other type of storage devices. One or more microprocessors or general-purpose computers with communication processing capability may be programmed with corresponding executable instructions and perform the disclosed network function(s) or algorithm(s). The microprocessors or general-purpose computers may include Application Specific Integrated Circuitry (ASIC), programmable logic arrays, and/or using one or more Digital Signal Processor (DSPs). Although some of the disclosed implementations are oriented to software installed and executing on computer hardware, alternative implementations implemented as firmware or as hardware or as a combination of hardware and software are well within the scope of the present disclosure.

The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture, such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network, such as a Core Network (CN), an Evolved Packet Core (EPC) network, an Evolved Universal Terrestrial RAN (E-UTRAN), a 5G Core (5GC), or an internet via a RAN established by one or more BSs.

A UE may include but is not limited to a mobile station, a mobile terminal or device, or a user communication radio terminal. The UE may be a portable radio equipment that includes but is not limited to a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may include but is not limited to a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

ABS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS is operable to provide radio coverage to a specific geographical area using a plurality of cells forming the RAN. The BS supports the operations of the cells. Each cell is operable to provide services to at least one UE within its radio coverage. Each cell (often referred to as a serving cell) may provide services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells. A cell may allocate sidelink (SL) resources for supporting Proximity Service (ProSe) or Vehicle to Everything (V2X) service. Each cell may have overlapped coverage areas with other cells.

As discussed above, the frame structure for NR supports flexible configurations for accommodating various next generation (e.g., 5G) communication requirements such as Enhanced Mobile Broadband (eMBB), Massive Machine Type Communication (mMTC), and Ultra-Reliable and Low-Latency Communication (URLLC), while fulfilling high reliability, high data rate and low latency requirements. The Orthogonal Frequency-Division Multiplexing (OFDM) technology in the 3rd Generation Partnership Project (3GPP) may serve as a baseline for an NR waveform. The scalable OFDM numerology such as adaptive sub-carrier spacing, channel bandwidth, and Cyclic Prefix (CP) may also be used. Additionally, two coding schemes are considered for NR, specifically Low-Density Parity-Check (LDPC) code and Polar Code. The coding scheme adaption may be configured based on channel conditions and/or service applications.

Moreover, it is also noted that in a transmission time interval TX of a single NR frame, at least downlink (DL) transmission data, a guard period, and uplink (UL) transmission data should be included, where the respective portions of the DL transmission data, the guard period, and the UL transmission data should also be configurable, for example, based on the network dynamics of NR. In addition, sidelink resources may also be provided in an NR frame to support ProSe services.

In addition, the terms “system” and “network” herein may be used interchangeably. The term “and/or” herein is only an association relationship for describing associated objects and represents that these relationships may exist. For example, A and/or B may indicate that: A exists alone, A and B exist at the same time, or B exists alone. In addition, the character “/” herein generally represents that the former and latter associated objects are in an “or” relationship.

Examples of some selected terms are provided as follows.

Beam: The term “beam” may be replaced by the term “spatial filter.” For example, when a UE reports a preferred gNB TX beam, the UE is essentially selecting a spatial filter used by the gNB. The term “beam information” is used to provide information about which beam/spatial filter is being used/selected. Individual reference signals are transmitted by applying individual beams/spatial filters. Thus, the term “beam” or “beam information” may be represented by the term “reference signal resource index(es).”

Antenna Panel: It may be assumed that an antenna panel is an operational unit for controlling a transmit spatial filter/beam. An antenna panel typically includes several antenna elements. A beam may be formed by an antenna panel and in order to form two beams simultaneously, two antenna panels are needed. Such simultaneous beamforming from multiple antenna panels is subject to UE capability. A similar definition for “antenna panel” may be possible by applying spatial receiving filtering characteristics.

Hybrid Automatic Repeat Request (HARQ): A functionality ensures delivery between peer entities at Layer 1 (i.e., Physical Layer). A single HARQ process supports one Transport Block (TB) when the physical layer is not configured for downlink/uplink spatial multiplexing, and when the physical layer is configured for downlink/uplink spatial multiplexing, a single HARQ process supports one or multiple TBs. There is one HARQ entity per serving cell. Each of HARQ entity supports a parallel of DL and UL HARQ process.

Timer: A Medium Access Control (MAC) entity may setup one or more timers for individual purposes, for example, triggering some uplink signaling retransmission or limiting some uplink signaling retransmission period. A timer is running once it is started, until it is stopped or until it expires; otherwise, it is not running. A timer may be started if it is not running, or may be restarted if it is running. A timer may be always started or restarted from an initial value. The initial value may be but not limited to be configured by the gNB via downlink Radio Resource Control (RRC) signaling.

Bandwidth Part (BWP): A subset of the total cell bandwidth of a cell is referred to as a BWP and beamwidth part adaptation is achieved by configuring the UE with BWP(s) and telling the UE which of the configured BWPs is currently the active one. To enable Bandwidth Adaptation (BA) on a Primary Cell (PCell), the gNB configures the UE with UL and DL BWP(s). To enable BA on Secondary Cells (SCells) in case of Carrier Aggregation (CA), the gNB configures the UE with DL BWP(s) at least (i.e., there may be none in the UL). For the PCell, the initial BWP is the BWP used for initial access. For the SCell(s), the initial BWP is the BWP configured for the UE to first operate at SCell activation. The UE may be configured with a first active uplink BWP by a firstActiveUplinkBWP Information Element (IE). If the first active uplink BWP is configured for a Special Cell (SpCell), the firstActiveUplinkBWP IE field contains the Identity (ID) of the UL BWP to be activated upon performing the RRC (re-)configuration. If the field is absent, the RRC (re-)configuration does not impose a BWP switch. If the first active uplink BWP is configured for an SCell, the firstActiveUplinkBWP IE field contains the ID of the UL BWP to be used upon MAC-activation of an SCell.

Quasi Co-Location (QCL): Two antenna ports are considered to be quasi co-located if properties of the channel over which a symbol on one antenna port is conveyed may also be inferred from the channel over which a symbol on the other antenna port is conveyed. The properties of the channel may include Doppler shift, Doppler spread, average delay, delay spread, and spatial RX parameters. These properties are categorized into different QCL types in NR specifications. For example, a QCL-TypeD may refer to a spatial RX parameter. The QCL-TypeD may also be referred to as a “beam” in the present disclosure.

Transmission Configuration Indication (TCI) state: A TCI state contains parameters for configuring a QCL relationship between one or two DL reference signals and a target reference signal set. For example, a target reference signal set may be the Demodulation Reference Signal (DMRS) ports of a Physical Downlink Shared Channel (PDSCH) or a Physical Downlink Control Channel (PDCCH).

Beam failure recovery (BFR): The movements in the environment, or other events, may lead to a currently established beam pair being rapidly blocked without sufficient time for the regular beam to adjust to adapt based on a beam reporting mechanism (e.g., a beam reporting mechanism is similar to a channel state information (CSI) reporting mechanism taken place in physical (PHY) channels). A beam failure recovery procedure deals with such occurrences with a short reaction time.

Normal Scheduling Request (SR): The normal SR may be used for requesting Uplink Shared Channel (UL-SCH) resource (e.g., a Physical Uplink Shared Channel (PUSCH) resource) for a new transmission. The UE may be configured with zero, one, or more normal SR configurations. A normal SR configuration may include a set of Physical Uplink Control Channel (PUCCH) resources for SR across different BWPs and cells. For a logical channel, at most one PUCCH resource for SR is configured per BWP. Each normal SR configuration may correspond to one or more logical channels. Each logical channel may be mapped to zero or one normal SR configuration. The normal SR configuration of the logical channel that triggers the BSR (e.g., when such a configuration exists) is considered as corresponding to a normal SR configuration for the triggered SR. When a normal SR is triggered, it may be considered as pending until it is cancelled.

For QCL assumption indication in DL, the TCI framework is introduced in 3GPP NR Release 15/16 (Rel-15/16). In 3GPP NR Rel-15/16, different QCL types have been defined for indicating different parameters for a DL synchronization purpose, including timing/frequency/spatial domain synchronization. Among them, the spatial domain synchronization may be often referred to as a beam or a spatial filter. For UL synchronization in a spatial or beam domain, a spatial relation information parameter has been introduced in the 3GPP NR Rel-15 (and later versions). One of the reasons for applying different principles for indicating DL/UL spatial domain filter characteristics is that the overhead on synchronization parameters in a UL direction is less than in a DL direction.

The beam indication for DL channels/signals may be a TCI (which includes beam indication information) indication for the DL Channel State Information-Reference Signal (CSI-RS). For periodic CSI-RS, the TCI may be configured by the RRC signaling. For semi-persistent (SP) CSI-RS, the TCI may be provided by a MAC CE when the SP CSI-RS is activated. For an aperiodic (SP) CSI-RS, the TCI may be configured by the RRC signaling in the associated trigger states.

The beam indication for DL channels/signals may be a TCI indication for a PDSCH. A first set of TCI states may be configured by the RRC layer. The MAC CE signaling may activate a subset from the first set of TCI states for beam indication or reception of the PDSCH. The Downlink Control Information (DCI) signaling may dynamically indicate a TCI state for scheduled the PDSCH transmission.

The beam indication for DL channels/signals may be a TCI indication for a PDCCH. A second set of TCI states may be configured by the RRC layer for the PDCCH. The configuration for the second set of TCI states may be per-Control Resource Set (CORESET) signaling. The MAC CE signaling may activate one from the second set of TCI states. The second set of TCI states may be a subset of the first set of TCI states.

The beam indication for UL channels/signals may be a beam indication for a UL Sounding Reference Signal (SRS). For periodic SRS, the spatial transmission property (e.g., beam indication for UL) may be configured by RRC. For an SP/aperiodic (AP) SRS, the spatial transmission property may be provided and/or updated by a MAC CE signaling.

The beam indication for UL channels/signals may be a beam indication for a PUCCH. A set of spatial transmission properties may be configured by RRC for PUCCH resources. The MAC CE signaling may be used to activate a spatial transmission property in the set of spatial transmission properties for transmission of a PUCCH resource.

The beam indication for UL channels/signals may be a beam indication for a PUSCH. The spatial transmission property of PUSCH transmission may refer to one or more RRC-configured SRS resources. The DCI signaling may be used to indicate a spatial transmission property, from the one or more RRC-configured SRS resources, for a scheduled PUSCH transmission. By referring to an RRC-configured SRS resource as a spatial transmission property, the PUSCH transmission may assume a same spatial transmission property as that applied to the referred RRC-configured SRS resource. The spatial transmission property of the RRC-configured SRS resource may be updated by the MAC CE signaling.

To simplify a beam indication overhead, a common beam indication may be applied to a set of channels and/or signals, instead of indicating beam information individually. The common beam operation may be considered in two aspects: a joint DL/UL common beam operation and separate DL/UL common beam operations.

The joint DL/UL common beam operation may assume that a same common beam indication is applicable to the specific channels/signals in both DL and UL directions. This may be achieved by a same beam indication signaling and may require beam correspondence capability to be supported by a UE. The separate DL/UL common beam operations may assume that respective common beams is applicable to respective DL channels/signals and UL channels/signals individually. This may be achieved by different indication signaling for the DL and UL common beams. The beam correspondence capability may not be necessary for a UE operating in the separate DL/UL common beam operations. A beam correspondent UE may not always perform the joint DL/UL common beam operation when the separate DL/UL common beam operations are, for example, enabled by the network (NW). There may be situations where different beams are preferred for DL reception and UL transmission, for example, due to Maximum Power Emission (MPE) considerations. In this situation, even though beam correspondence and the joint common beam operation are supported by the UE, the separate DL/UL common beam operation may be applied.

One method for such common beam operation is to reuse the PDSCH beam indication framework (e.g., as described in 3GPP NR Rel-15/16). That is, the MAC CE signaling may be used to activate a subset of TCI states from a set of TCI states configured by the RRC layer. Then, the DCI may be used to indicate/update a common beam to be applied to a (pre-)configured/(pre-)specified channels/signals. The common beam may be a joint DL/UL common beam, or a DL or UL beam in separate DL/UL common beams. In such a framework, the following issues (a)-(c) need to be addressed.

(a) Indication signaling details for the common beam indication, including the joint DL/UL common beam and the separate DL/UL common beam.

(b) Acknowledgement of successful reception of the common beam indication. It should be noted that since an indicated common beam may be applied to multiple receptions/transmissions, the penalty of not receiving the common beam indication may be large compared to the PDSCH beam indication, for example, as described in 3GPP NR Rel-15/16.

(c) Common beam operation may be potentially applied in a multi-Transmission Reception Points (TRPs) scenario, where a UE may communicate with more than one TRP. Since TRPs are not co-located in general, different common beams may need to be indicated for communicating with multiple TRPs.

For common beam indication, various DCI format(s) may be considered. In the present disclosure, existing DCI format(s) with dedicated use for common beam indication may be considered. Field value(s) of the DCI format(s) may be set to specific values for identifying a received DCI format as a common beam indication. Specific Field(s) of the DCI format(s) may be reused for indicating common beam(s). For acknowledgement of common beam indication, methods for adding extra HARQ-ACK bits for common beam indication(s) in a HARQ-ACK codebook is proposed. Additionally, a new MAC CE for confirming successful reception of common beam indication is also proposed. For all methods, both joint DL/UL common beam operation and separate DL/UL common beam operation are considered.

The methods proposed in this disclosure may be applied to the both joint DL/UL common beam operation and separate DL/UL common beam operation, if not stated otherwise. A 3-step common beam indication framework where Layer-3 RRC, Layer-2 MAC CE and Layer-1 DCI signaling may be involved. Since one common beam indication may be applied to multiple receptions/transmissions of specific (DL and/or UL) channels/signals, making sure the indication is successfully received is crucial. In this sense, not only indication signaling, but also acknowledgement signaling of the indication reception may need to be devised.

Depending on the system design, M common beam(s) may be assumed, where M=1 or M>1. While M=1 may simplify the system design, M>1 may find its application in, for example, a multi-TRP scenario. M=1 may be restricted to a single-TRP scenario. M>1 may be required for an inter-cell/intra-cell multi-TRP scenario. M>1 may be required for a generic multi-TRP scenario. M>1 may be referred to as a common beam indication may (only) to be applicable for some of DL channels and/or signals. It should be noted that a multi-TRP scenario may be identified based on the RRC parameter(s). For example, when a parameter CORESETPoolIndex is not configured for any CORESET, or no CORESET is configured with a parameter CORESETPoolIndex 1, a single-TRP scenario may be assumed. For differentiating between an intra-cell multi-TRP and an inter-cell multi-TRP, additional parameter(s) may be needed.

In a single-TRP (s-TRP) scenario, one DL common beam may be applied to a UE in DL and one UL common beam may be applied to the UE in UL. In a joint DL/UL common beam operation, the DL common beam and the UL common beam may be the same. In a separate DL/UL common beam operation, the DL common beam and the UL common beam may be different. In a multi-TRP (m-TRP) scenario, M DL common beam(s) may be applied to a UE in DL and N UL common beam(s) may be applied to the UE in UL. In a joint DL/UL common beam operation, the DL common beam and the UL common beam may be the same, and M may be equal to N. In a separate DL/UL common beam operation, the DL common beam and the UL common beam may be different, and M may or may not be equal to N. In the present disclosure, the term “gNB” may be replaced by other terms, such as a network node, a cell, or a base station (BS).

The DL DCI format(s) may be applied to the common beam indication. For example, DCI 1_0, DCI 1_1, or DCI 1_2 may be applied to the common beam indication. In some implementations, more than one of DCI 1_0, DCI 1_1 and DCI 1_2 may be applied to the common beam indication. In some implementations, the group common DCI may be applied to the common beam indication for a group of UEs. The DCI format(s) used for the common beam indication may be at least one of the following (a)-(d).

(a) A dynamic resource scheduling DCI for a PDSCH and/or a PUSCH.

(b) A Semi-persistent scheduling (SPS) PDSCH scheduling activation/release DCI (or PDCCH), as specified in e.g., the 3GPP Technical Specification (TS) 38.213 V16.2.0. The SPS scheduling activation/release DCI may be used for activation/release of at least one SPS configuration. The release of a SPS configuration may be referred as the de-activation of the SPS configuration. The SPS scheduling activation/release DCI may be used for activation of a single or multiple SPS configurations. The single or multiple SPS configurations may be configured in an active DL BWP for a scheduled cell related to the activation/release DCI.

(c) A UL Configured Grant (CG) PUSCH scheduling activation/release DCI (or PDCCH), as specified in, e.g., the 3GPP TS 38.213 V16.2.0. The UL CG may be a type 2 configured grant. The UL CG scheduling activation/release DCI may be used for activation/release of a single UL CG configuration. The UL CG scheduling activation/release DCI may be used for activation of a single or multiple UL CG configurations. The single or multiple UL CG configurations may be configured in an active UL BWP for a scheduled cell related to the activation/release DCI.

(d) A DCI format with Cyclic Redundancy Check (CRC)-scrambled by Cell-Radio Network Temporary Identifier (C-RNTI), Configured Scheduling (CS)-RNTI, or a new RNTI (e.g., compared to the RNTIs defined in the 3GPP TS 38.321 V16.2.0) are defined for the common beam indication.

The UE may validate a common beam indication signaling in a similar manner as for validating a DL SPS or a UL CG type 2 scheduling release/deactivation when the UE is provided with a single/multiple SPS configuration(s) or UL grant type 2 configuration(s) in an active DL/UL BWP of the scheduled cell of a DCI signaling. The UE may validate a common beam indication signaling when receiving the DCI with field(s) set/indicated as at least one of the following (a)-(c).

(a) The new data indicator field in the DCI format for an enabled Transport Block (TB) may be set to a specific value, e.g., “0.”

(b) The Downlink Feedback Information (DFI) flag field, if present, in the DCI format may be set to a specific value, e.g., “0.”

(c) The HARQ Process Number (HPN) field, the Redundancy Version (RV) field, the Modulation and Coding Scheme (MCS) field, and/or the Frequency Domain Resource Assignment (FDRA) field may be set to specific values. The HPN field may be set to a specific codepoint, e.g., all “0”s. The HPN field may be used to indicate adaptation of one or multiple common beams. The codepoint value of the HPN field may be mapped to one or a subset of the TCI states activated by the MAC CE for the common beam operation. The RV field may be set to a specific codepoint, e.g., all “0”s. The RV field may be used to indicate an adaptation of one or multiple common beams. The codepoint value of the RV field may be mapped to one or a subset of the TCI states activated by the MAC CE for the common beam operation. The MCS field may be set to a specific value, e.g., all “0”s. The MCS field may be used to indicate an adaptation of one or multiple common beams. The codepoint value of the MCS field may be mapped to one or a subset of the TCI states activated by the MAC CE for a common beam operation. The FDRA field may be set to specific values based on the configured FDRA type, e.g., all “1”s or all “0”s, as specified in, for example, the 3GPP TS 38.213 V16.2.0. All “0”s may mean that each bit in the field is set to “0”, and all “1”s may mean that each bit in the field is set to “1”.

The UE may validate a common beam indication signaling in a similar manner as for validating a DL SPS or a UL CG type 2 scheduling activation when the UE is provided with a single/multiple SPS configuration(s) or UL grant type 2 configuration(s) in an active DL/UL BWP of the scheduled cell of a DCI signaling. The UE may validate a common beam indication signaling when receiving the DCI with field(s) set/indicated as at least one of the following (a)-(c).

(a) The new data indicator field in the DCI format for an enabled TB may be set to a specific value, e.g., “0.”

(b) The DFI flag field, if present, in the DCI format may be set to a specific value, e.g., “0.”

(c) The HPN field and/or the RV field may be set to specific values. The HPN field may be set to a specific codepoint, e.g., all “0”s. The HPN field may be used to indicate an adaptation of one or multiple common beams. The codepoint value of the HPN field may be mapped to one or a subset of the TCI states activated by the MAC CE for the common beam operation. The RV field may be set to a specific codepoint, e.g., all “0”s. The RV field may be used to indicate an adaptation of one or multiple common beams. The codepoint value of the RV field may be mapped to one or a subset of the TCI states activated by the MAC CE for the common beam operation. All “0”s may mean that each bit in the field is set to “0”, and all “1”s may mean that each bit in the field is set to “1”.

For mapping a DCI field codepoint to one or a subset of the MAC CE activated TCI states, the codepoint may be a bit map that maps to the MAC CE activated TCI states. Individual bits may correspond to individual activated TCI state positions. More than one activated TCI state may be indicated by the bit map. A specific TCI state position may include more than one activated TCI states. For mapping a DCI field codepoint to one or a subset of the TCI states indicated in the MAC CE, the codepoint may be mapped to one or multiple TCI states. The codepoint may indicate a specific TCI state position in the MAC CE. A specific TCI state position may include more than one activated TCI state.

The DCI format for common beam indication may indicate more than one common beam. Individual common beams may be mapped to transmissions/receptions related to individual TRPs in a (pre-)configured/(pre-)specified manner. The first (indicated/specified) common beam may be applied to transmissions/receptions related to the first TRP. The second (indicated/specified) common beam may be applied to transmissions/receptions related to the second TRP. The first/second TRP may be determined by an index associated with the TRP, e.g., a CORESETPoolIndex, or a TRP index. The first TRP may be associated with a TRP with the lowest TRP index, and the second TRP may be associated with a TRP with the second lowest TRP index. Individual common beams may be mapped to transmissions/receptions related to individual UE panels in a (pre-)configured/(pre-)specified manner. The first (indicated/specified) common beam may be applied to transmissions/receptions related to the first UE panel. The second (indicated/specified) common beam may be applied to transmissions/receptions related to the second UE panel. The first/second UE panel may be determined by an index (e.g., a panel index) associated with each panel. The first UE panel may be associated with a panel with the lowest panel index, and the second UE panel may be associated with a panel with the second lowest panel index. The panel index may be associated with the SRS resource set index.

There may be one or more (additional) fields for identifying the common beam indication in the DCI format. There may be a combination of one or more (additional) fields indicating one or more specific values for identifying the common beam indication in the DCI format. The DCI format(s) may be a DL DCI format(s) or a UL DCI format(s). The DL DCI format(s) may be applied to the joint DL/UL common beam indication. The DL DCI format(s) may be applied to the DL common beam indication in the separate DL/UL common beam operation. The UL DCI format(s) may be applied to the UL common beam indication in the separate DL/UL common beam operation. For each separate DL/UL common beam indication, one DCI signaling may be used for indicating only one of DL and UL common beam update.

An acknowledgement of a successful reception of the common beam indication may ensure common understanding on the communication means taken by the gNB and the UE. Since the indicated common beam(s) may be applied for multiple receptions/transmissions, the penalty of not receiving a common beam indication correctly may be larger compared to the beam indication for a PDSCH (e.g., as described in the 3GPP NR Rel-15/16). Following the 3-step common beam indication framework, an acknowledgement signaling may reuse the feedback procedure as specified in, e.g., the 3GPP TS 38.213 V16.2.0 and/or the 3GPP TS 38.321 V16.2.0, but with some modifications.

The feedback confirmation for the DL scheduling may be performed by the UE, e.g., via the HARQ-ACK feedback. While the DL reception may trigger the HARQ-ACK feedback, the motivation and thus the determination of ACK/NACK bits may not be the same for different types of receptions. For DG/SPS PDSCH, a HARQ-ACK bit may indicate the decoding state of the scheduled PDSCH. For SPS PDSCH release DCI, it may ensure the common understanding between the gNB and the UE by acknowledging the reception of such a release command. The feedback confirmation for the UL scheduling, on the other hand, may be performed by the UL MAC CE feedback generated by the UE. The MAC CE confirmation message may be included in a data channel, e.g., a PUSCH, based on dynamically scheduled or pre-configured UL resources.

The HARQ-ACK bit may be applied as an acknowledgement of the common beam indication. The HARQ-ACK bit may be included in a HARQ-ACK codebook, and may be transmitted by the UE to the gNB, e.g., via the PUSCH or the PUCCH. Both ACK and NACK may be used as an acknowledgement. The DTX may be used for indicating a missed reception of the common beam indication by the UE. The HARQ-ACK bit applied for an acknowledgement of the common beam indication may be associated with DCI or a PDSCH. The PDSCH may be a DG PDSCH. The PDSCH may be an SPS PDSCH. The DCI may be a modified or newly-interpreted version of the SPS PDSCH activation/release DCI or the CG type 2 PUSCH activation release DCI. The HARQ-ACK bit may correspond to a successful reception of more than one common beam in one common beam indication.

The HARQ-ACK bit(s) as an acknowledgement of the common beam indication may be applied to the joint DL/UL common beam operation. The HARQ-ACK bit(s) as an acknowledgement of the common beam indication may be applied to the DL common beam indication in the separate DL/UL common beam operation. The HARQ-ACK bit(s) as an acknowledgement of the common beam indication may be applied to the UL common beam indication in the separate DL/UL common beam operation. The HARQ-ACK bit(s) as an acknowledgement of the common beam indication may be (extra) bits attached or inserted to an existing HARQ-ACK codebook(s) (e.g., the HARQ-ACK codebook(s), as specified in the 3GPP TS 38.213 V16.3.0). The (extra) bits may be attached to a specific position of the HARQ-ACK codebook(s). For example, the (extra) bits may be attached to the ending part of the HARQ-ACK codebook(s). That is, the (extra) bits may be the Least Significant Bits (LSBs) of the HARQ-ACK codebook(s). The (extra) bits may be attached to a specific portion of the HARQ-ACK codebook(s) corresponding to a TRP. For example, the (extra) bits may be attached to the ending part of the HARQ-ACK codebook(s) corresponding to a TRP. That is, the (extra) bits may be the Least Significant Bits (LSBs) of the HARQ-ACK codebook(s) corresponding to a TRP. The HARQ-ACK bit(s) as an acknowledgement of the common beam in a HARQ-ACK codebook may include only one bit. The UE may not include/attach more than one HARQ-ACK bit as an acknowledgement of the common beam in a HARQ-ACK codebook. For a common beam indication applied to a TRP, the HARQ-ACK bit(s) as an acknowledgement of the common beam in a HARQ-ACK codebook may include only one bit. For a common beam indication applied to a TRP, the UE may not include/attach more than one HARQ-ACK bit as an acknowledgement of the common beam in a HARQ-ACK codebook.

A MAC CE confirmation message may be used as an acknowledgement of the common beam indication. The MAC CE confirmation message may be identified by a Logical Channel ID (LCD). The confirmation message may have a fixed size of zero bit. The confirmation message having a fixed size of zero bit may be applied to all common beam operation modes in an s-TRP case. The confirmation message may have a fixed/variable size of non-zero bits. The confirmation message having a fixed/variable size of non-zero bits may be applied to the separate DL/UL common beam operation. There may be a field in the confirmation message for indicating that either a DL common beam or a UL common beam is acknowledged. The confirmation message having a fixed/variable size of non-zero bits may be applied when more than one common beam is operating or is indicated in the indication. The confirmation message having a fixed/variable size of non-zero bits may be applicable in the joint DL/UL common beam operation or in the separate DL/UL common beam operation. The indication field in the confirmation message having a fixed/variable size of non-zero bits may simply indicate a successful reception of a common beam indication, where the common beam indication may include more than one common beam. The indication field(s) in the confirmation message having a fixed/variable size of non-zero bits may indicate a successful reception of more than one common beam individually in a common beam indication, where the common beam indication may include more than one common beam.

There may be only one common beam in the joint DL/UL beam operation for at least one serving cell. There may be only one common beam in the joint DL/UL beam operation for a TRP in at least one serving cell. There may only be one DL common beam in the separate DL/UL beam operation for at least one serving cell. The MAC CE confirmation message may acknowledge the reception of the DL common beam indication for the at least one serving cell. There may only be one UL common beam in the separate DL/UL beam operation for at least one serving cell. The MAC CE confirmation message may acknowledge the reception of the UL common beam indication for the at least one serving cell. There may be only one DL common beam in the separate DL/UL beam operation for a TRP in at least one serving cell. The MAC CE confirmation message may acknowledge the reception of the DL common beam indication for the TRP in the at least one serving cell. There may only be one UL common beam in the separate DL/UL beam operation for a TRP in at least one serving cell. The MAC CE confirmation message may acknowledge the reception of the UL common beam indication for the TRP in the at least one serving cell. The DCI for common beam indication may be a modified version of the SPS PDSCH activation/release DCI and/or the CG type 2 PUSCH activation/release DCI. The MAC CE confirmation may carry/indicate information for one or more serving cells. All or some of the one or more serving cells indicated in the MAC CE confirmation may be configured with the CG configuration. The carried/indicated information may be at least one of the following types (a)-(c), where the type of the carried/indicated information may not be the same across all the one or more serving cells indicated in the MAC CE. (a) Confirmation of CG activation/release; (b) Confirmation of common beam indication; and (c) Confirmation of both CG activation (or release) and common beam indication.

The UL power control for the PUCCH transmission may depend on the number of Uplink Control Information (UCI) bits carried in a PUCCH. The UCI bits may include HARQ-ACK bits (O_{ACK}), Scheduling Request (SR) bits (O_{SR}), and Channel State Information (CSI) bits (O_{CSI}). In a case that the number of the UCI bits (O_{ACK}+O_{SR}+O_{CSI})≤11, the UE may determine another number of HARQ-ACK bits (n_{HARQ-ACK}), which may be applied for the power control purpose for the PUCCH transmission. The HARQ-ACK bits (O_{ACK}) may include the (extra) bits for the acknowledgement of the common beam indication.

If none of the serving cells is configured to perform a code block group (CBG)-based HARQ operation, or for PDSCH receptions scheduled by a DCI format that does not support CBG-based PDSCH receptions, or for an SPS PDSCH reception, or for an SPS PDSCH release, or for a DCI format that provides the common beam indication without a resource allocation, and if the number of UCI bits is less than or equal to 11, the value of the HARQ-ACK bits (n_{HARQ-ACK}) may be determined for deriving the UL power for the PUCCH transmission. Such an implementation for deriving the UL power for the PUCCH transmission may be applicable to the HARQ Typel (semi-static) and Type 2 (dynamic) codebook. For example, for a dynamic codebook, the value of the HARQ-ACK bits (n_{HARQ-ACK}) may be determined based on the Equation 1 below. Equation 1 is based on the formulation (e.g., as described in 3GPP NR Rel-15/16), for example, as specified in the 3GPP TS 38.213 V16.4.0, but with the definitions of the parameters modified as detailed below.

n_{HARQ-ACK}=n_{HARQ-ACK,TB}=((V_{DAI,M}_{ₗₐₛₜ}^{DL}−Σ_{c=0}^{N}^{_{cells}}^{^{DL}}⁻¹U_{DAI,c})mod 4)N_{TB,max}^{DL}+Σ_{c=0}^{N}^{_{cells}}^{^{DL}}⁻¹(Σₘ₌₀^{M-1}N_{m,c}^{received}+N_{SPS,c}) (Equation 1), where:

ND_{cells}^{DL} is the number of serving cells configured by higher layers of the UE.

M is the cardinality of a set of PDCCH monitoring occasions for the PDCCH with a DCI format scheduling PDSCH receptions or SPS PDSCH release or optionally a DCI format that provides a common beam indication without a resource allocation across active DL BWPs of the configured serving cells for which a UE transmits HARQ-ACK information in a same PUCCH in the slot n. The PDCCH monitoring occasions may be arranged in an ascending order of the start time of the search space set associated with a PDCCH monitoring occasion.

If N_{cells}^{DL}=1, V_{DAI,M}_{ₗₐₛₜ}^{DL} is the value of the counter Downlink Assignment Index (DAI) in the last valid DCI format scheduling a PDSCH reception or indicating an SPS PDSCH release or optionally indicating the common beam indication without a resource allocation for any serving cell c that the UE detects within the M PDCCH monitoring occasions.

If N_{cells}^{DL}>1, and the UE does not detect any DCI that includes a total DAI field in a last PDCCH monitoring occasion within the M PDCCH monitoring occasions where the UE detects at least one DCI format scheduling a PDSCH reception or indicating an SPS PDSCH release or optionally indicating a common beam indication without a resource allocation for any serving cell c, V_{DAI,M}_{ₗₐₛₜ}^{DL} is the value of the counter DAI in a last a valid DCI format the UE detects in the last PDCCH monitoring occasion.

If N_{cells}^{DL}>1, and the UE detects at least one DCI format that includes a total DAI field in a last PDCCH monitoring occasion within the M PDCCH monitoring occasions where the UE detects at least one DCI format scheduling a PDSCH reception or indicating an SPS PDSCH release or optionally indicating the common beam indication without a resource allocation for any serving cell c, V_{DAI,M}_{ₗₐₛₜ}^{DL} is the value of the total DAI in the at least one DCI format that includes a total DAI field.

V_{DAI,M}_{ₗₐₛₜ}^{DL}=0, if the UE does not detect any DCI format scheduling a PDSCH reception or indicating an SPS PDSCH release or optionally indicating the common beam indication without a resource allocation for any serving cell c in any of the M PDCCH monitoring occasions.

U_{DAI,c} is the total number of a DCI format scheduling the PDSCH receptions or indicating the SPS PDSCH release or optionally indicating the common beam indication, without a resource allocation, that the UE detects within the M PDCCH monitoring occasions for serving cell c. U_{DAI,c}=0 if the UE does not detect any DCI format scheduling a PDSCH reception or indicating an SPS PDSCH release or optionally indicating the common beam indication without a resource allocation for serving cell c in any of the M PDCCH monitoring occasions.

N_{TB,max}^{DL}=2, if the value of the parameter maxNrofCodeWordsScheduledByDCI provided by higher layers is 2 for any serving cell c and the parameter harq-ACK-SpatialBundlingPUCCH is not provided; otherwise, N_{TB,max}^{DL}=1.

N_{m,c}^{received} is the number of transport blocks the UE receives in a PDSCH scheduled by a DCI format that the UE detects in PDCCH monitoring occasion m for serving cell c if the parameter harq-ACK-SpatialBundlingPUCCH is not provided, or the number of PDSCHs scheduled by a DCI format that the UE detects in PDCCH monitoring occasion m for serving cell c if the parameter harq-ACK-SpatialBundlingPUCCH is provided, or the number of DCI formats that the UE detects and indicate an SPS PDSCH release or optionally indicating the common beam indication without a resource allocation in PDCCH monitoring occasion m for serving cell c.

N_{SPS,c} is the number of SPS PDSCH receptions by the UE on serving cell c for which the UE transmits corresponding HARQ-ACK information in the same PUCCH as for HARQ-ACK information corresponding to PDSCH receptions within the M PDCCH monitoring occasions.

When counting the number of DCI formats received, the DCI format(s) used for indicating the common beam indication without (DL and/or UL) a resource allocation may be (additionally) counted. Such an implementation may be applicable to a semi-static codebook case, and to the case when CBG-based HARQ operation is applied/configured. Such an implementation may be applicable to the m-TRP case or to the case where more than one common beam is indicated/operating. In a case that more than one TRP is considered in a serving cell, all DCI formats indicating the common beam indication without resource allocation from all TRPs may need to be counted. The acknowledge bits for the common beam indication may be considered by the UE when determining parameters or values associated with the UL power control.

In 3GPP NR Rel-15, the link recovery (e.g., Beam Failure Recovery (BFR)) for special cells (e.g., Primary Cell, Primary Secondary Cell) is supported. In 3GPP NR Rel-16, the link recovery for SCells was introduced as well. The link recovery may include the following four steps (a)-(d).

(a) Beam Failure Detection (BFD): A beam failure event of a BWP of a serving cell may be detected based on an implicitly or explicitly configured BFD reference signal (RS).

(b) New beam identification (NBI): An alternative beam for recovering a link that is detected as beam failure may be identified based on configured RSs.

(c) Beam Failure Recovery reQuest (BFRQ) transmission: The information needed for recovering the link may be delivered by a BFRQ transmission. The BFRQ transmission may be a Physical Random Access Channel (PRACH)-based transmission for special cells or a PUSCH-based transmission (carried in the MAC CE) for SCells.

(d) gNB response reception for completing the link recovery by the UE: For special cells, the UE may monitor a PDCCH transmission on a dedicatedly configured search space to determine if the BFRQ is successfully received by the gNB or not. For SCells, the UE may monitor a UL DCI (PDCCH) transmission which indicates the same HARQ process ID as the HARQ process ID used for the BFRQ PUSCH transmission, but with a toggled NDI field.

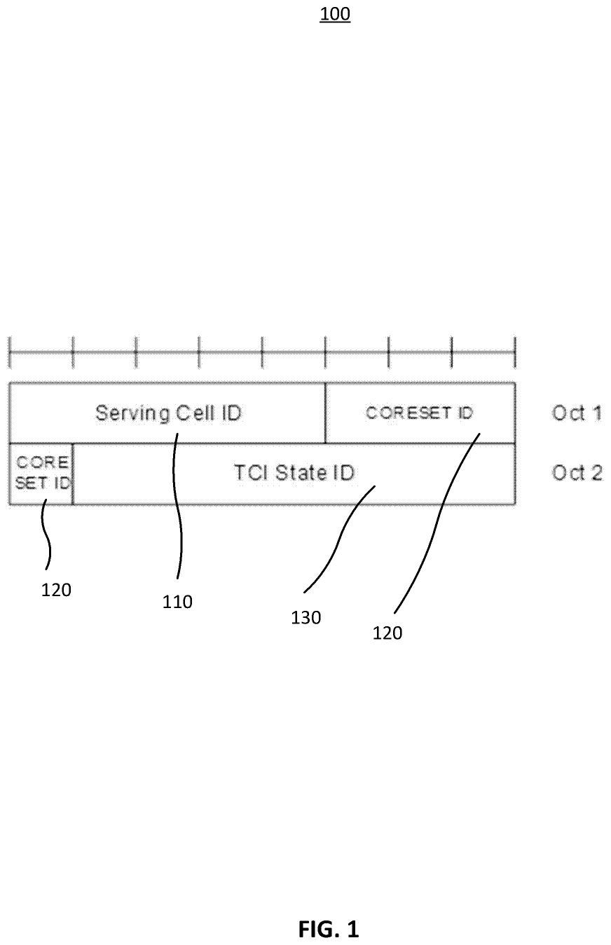

In 3GPP NR Rel-17, the multi-TRP scenario may be extended for a DL control channel, e.g., a PDCCH. Details on how to derive the BFD RS(s) implicitly need to be devised. In 3GPP NR Rel-15/16, the QCL assumption for a transmission may be indicated via the TCI state. For a PDCCH reception, a set of candidate TCI states may be configured (e.g., through RRC signaling) to a CORESET, with a number constraint maxNrofTCI-StatesPDCCH. Among the set of candidate TCI states, a TCI state may be activated for the CORESET by the MAC-CE signaling. FIG. 1 is a schematic diagram illustrating a MAC CE format 100 with a fixed size of 16 bits that is used for activating a TCI state for a CORESET, according to an example implementation of the present disclosure. The MAC CE format 100 may include several fields, such as Serving Cell ID 110, CORESET ID 120, and TCI State ID 130. In the following, the fields of the Serving Cell ID 110, the CORESET ID 120, and the TCI State ID 130 are described.

Serving Cell ID 110: This field indicates the identity of the Serving Cell for which the MAC CE applies. The length of the field is 5 bits.

CORESET ID 120: This field indicates a CORESET identified with the parameter ControlResourceSetId as specified in, e.g., the 3GPP TS 38.331 V16.2.0, for which the TCI state is indicated. In a case that the value of the field is 0, the field may refer to the CORESET configured by the parameter controlResourceSetZero as specified in, e.g., the 3GPP TS 38.331 V16.2.0. The length of the field is 4 bits.

TCI State ID 130: This field indicates the TCI state identified by the parameter TCI-StateId as specified in, e.g., the 3GPP TS 38.331 V16.2.0 applicable to the CORESET identified by CORESET ID field. If the field of CORESET ID is set to 0, this field indicates a parameter TCI-StateId for a TCI state of the first 64 TCI-states configured by the parameters tci-States-ToAddModList and tci-States-ToReleaseList in the PDSCH-Config in the active BWP. If the field of CORESET ID is set to other value than 0, this field indicates a parameter TCI-StateId configured by parameters tci-StatesPDCCH-ToAddList and tci-StatesPDCCH-ToReleaseList in the controlResourceSet identified by the indicated CORESET ID. The length of the field is 7 bits.

In 3GPP NR Rel-15/16, the BFD RS, which is used for detecting a beam failure condition, may be either explicitly configured or implicitly configured. The explicit configuration of BFD RS(s) may be based on explicit RRC signaling. The implicit configuration may take place when the BFD RS(s) is not explicitly configured. For the implicit configuration, the UE may determine the BFD RS(s) by including the RS(s) in the RS sets indicated by the TCI state for a respective CORESET that the UE uses for monitoring the PDCCH. If there are two RS indexes in a TCI state, the RS with the QCL-TypeD configuration for the corresponding TCI state may be included. Based on the current 3GPP specifications (e.g., the 3GPP TS 38.213 V16.3.0), up to 2 BFD RSs may be explicitly configured for a BWP. In 3GPP NR Rel-15, up to 3 CORESETs per BWP may be configured while in 3GPP NR Rel-16 multi-PDCCH based multi-TRP transmission, up to 5 CORESETs per BWP may be configured. For an implicit BFD RS selection, there may be no specified rule for selecting BFD RS(s) when the number (e.g., 3) of PDCCH TCI states (e.g., each TCI state corresponding to a CORESET within a concerned BWP) is larger than the number (e.g., 2) of BFD RS to be selected. The implicit BFD RS selection may be determined based on the UE implementation.

The implicit BFD RS configuration may be applicable to a beam failure recovery for either the special cell(s) or for the SCell(s). The Radio Link Monitoring (RLM) RS(s) may be determined implicitly, as well, when the RLM RS(s) is not explicitly configured. For the implicit RLM RS configuration, the RLM RS(s) may be selected based on a PDCCH reception of TCI states. When there are more PDCCH TCI states than the number of RLM RS to be selected, the following Method #A selection rule may be applied. Method #A selection rule: The UE may select the required number of RSs provided for the active TCI states for the PDCCH receptions in the CORESETs associated with the search space sets in an order from the shortest monitoring periodicity. If more than one CORESET is associated with search space sets having the same monitoring periodicity, the UE may determine the order of the CORESETs from the highest CORESET index, as specified in the 3GPP TS 38.213. If the active TCI state for the PDCCH reception includes two RSs, one RS may have QCL-TypeD and the UE may use the RS with QCL-TypeD for radio link monitoring.

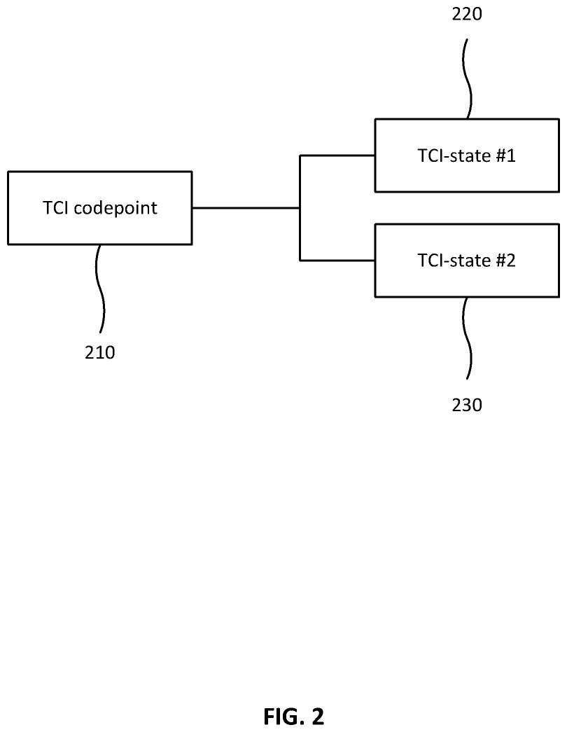

FIG. 2 is a schematic diagram illustrating an association of one TCI codepoint 210 with two TCI states 220 and 230, according to an example implementation of the present disclosure. In 3GPP NR Rel-16, the multi-TRP techniques may be applied to the PDSCH for improved reliability and robustness targeting to fulfill the URLLC requirements. As one of multi-TRP features, a codepoint in the TCI field in a DL DCI format may indicate up to 2 TCI states for the PDSCH scheduling, as illustrated in FIG. 2. When one TCI codepoint 210 is associated with 2 TCI states 220 and 230, the QCL assumptions indicated by both TCI states 220 and 230 may be applied to the PDSCH reception from the UE perspective. The association of TCI codepoints 210 with TCI states 220 and 230 may be signaled by the MAC CE signaling.

For PDCCH reliability and robustness, the PDCCH transmission may adopt a similar Spatial Division Multiplexing (SDN) or a Single Frequency Network (SFN) approach. That is, the DCI transmission may be received by the UE by applying multiple QCL assumptions. The transmission from individual QCL assumptions may be performed by different TRPs. This leads to the possibility of TRP-specific BFR. That is, (control) channel links from individual TRPs may be maintained/recovered by individual BFR procedure or two sub-procedure under a BFR procedure. From gNB perspective, as long as information provided in BFRQ may indicate which TRP is related to a degrading (control) channel link, subsequent steps in a BFR procedure may be performed to recover the link.

For TRP-specific BFR procedure, the UE may need to be able to learn which TRP is related to a degrading (control) channel link, so that a BFR procedure corresponding to the TRP may be triggered. The following two approaches (a) and (b) may be considered.

(a) Individual sets of BFD RS(s) for individual BFR procedures may be provided. That is, each TRP-specific BFR may be provided with its individual BFD RS sets. When channel quality of all or a subset of RS(s) in a BFD RS set falls below a specific threshold, a corresponding BFR procedure may be triggered. When the BFD RS is implicitly configured and a CORESET is provided with more than one activated TCI state, a rule for selecting/determining the BFD RS for each TRP-specific BFR procedure corresponding to the 2-TCI-state CORESET may be needed.

(b) Alternative approach is devised based on the observation that a (control) channel quality corresponding to a 2-TCI-state CORESET degrades when links correspond to both TRPs fail. In this situation, there may not be a need for differentiating the BFD RS(s) for different TRP-specific BFR procedures. Instead, a UE may simply need to have a rule to decide which TRP-specific BFR procedure(s) to trigger after determining that a beam failure associated with the channel quality of the 2-TCI-state CORESETs (optionally, and other related CORESET(s) of the beam failure detection) is detected.

The Beam failure procedure (BFR) is devised to quickly recover a failed link between a UE and a Base Station (BS) node, especially for a vulnerable beamformed transmission in a higher frequency, e.g., Frequency Range 2 (FR2), where wireless channel characteristics are less favorable for reliable transmission. Based on the BFR procedure, a set of BFD RSs may be defined. The set of BFD RSs may be monitored to derive a hypothetical PDCCH channel quality. If the quality is lower than a specific threshold, a beam failure detection may be declared. Upon the BFD, the UE may indicate to the BS the new beam(s) for a link recovery. Such aa message may be termed a Beam Failure Recovery request (BFRQ). The BFRQ may be transmitted based on a PRACH channel and/or may be a MAC CE based message. Both contention-based and contention-free PRACHs may be used for the BFRQ transmission for special cells. In a PRACH-based approach, new beam information may be implicitly carried in the selected PRACH resource. For a MAC CE based solution, more information may be carried, and the information may include the new beam(s), failed serving cell identity, etc. Upon delivery of the BFRQ, the UE may expect the BS to respond to confirm the reception of the BFRQ. Once the BFRQ is confirmed to be properly received (e.g., via a BS response), the UE may apply the new beam(s) for a DL reception in a (pre-)specific manner.

When more than 1 TRP is provided to the UE, the TRPs may be intra-cell TRPs or may be inter-cell TRPs. Two TRPs residing within a same serving cell, thus showing a same Physical Cell Identity (PCI), may be considered intra-cell TRPs. Two TRPs residing in different serving cells, thus showing different PCIs, may be considered inter-cell TRPs. Specifically, the TRP-specific BFR procedure may address a scenario where N>1 TRPs may be configured in a same serving cell or configured to serve a same serving cell. Among the N TRPs, M (TRPs may be provided with the BFR procedures individually. The total number of TRPs configured to a UE may be more than N. The TRP-specific BFR procedure may include at least one of the following features (a)-(c).

(a) More than one TCI state may be activated for a CORESET. In some implementations, two TCI states may be activated for a CORESET. In some implementations, the UE may be provided/configured with 2-TCI-state CORESET(s) and 1-TCI-state CORESET(s) at the same time. In some implementations, 2-TCI-state CORESET(s) and 1-TCI-state CORESET(s) may be configured to be associated with search space(s). The 1-TCI-state CORESET may stand for a CORESET with 1 activated TCI state.

(b) A UE may transmit a BFRQ indicating a beam failure detection of a TRP or a serving cell towards a gNB. The gNB may provide a response to indicate a successful reception of the BFRQ. After receiving the response provided by the gNB, a new beam (q_new) indicated by the UE in the BFRQ information may be applied to the PDCCH reception (e.g., by the UE) before further TCI state updated for the configured CORESETs.

© A TCI state may be provided with information for identifying a cell and/or a TRP.

For a beam failure detection purpose, the number of the BFD RS may be limited (e.g., two BFD RSs per BWP) and the number of the BFD RS may be smaller than the total number of TCI states for PDCCH monitoring over all related CORESET(s). The related CORESETs may be the CORESETs configured for a corresponding active BWP. When the BFD RS is to be determined implicitly from the TCI states/QCL assumption(s) of the PDCCH reception, a down selection on the TCI states may be needed. When an active TCI state for PDCCH reception includes two reference signals, the UE may assume that one RS has a QCL-TypeD and the UE may use the QCL-TypeD RS as BFD RS if the active TCI state is selected for a beam failure detection purpose. Furthermore, for a TRP-specific BFR procedure, how to associate a detected beam failure with a set of BFR procedures may need to be determined, especially in an implicit BFD RS configuration case. For such a purpose, the following (a) and (b) may be considered.

(a) Individual sets of BFD RS(s) for individual BFR procedures may be decided. When BFD RS (set) is implicitly configured/determined and at least one CORESET is provided with more than one activated TCI state, a rule for selecting/deciding the BFD RS for each TRP-specific BFR procedure corresponding to the 2-TCI-state CORESET may be applied.

(b) The TRP-specific BFR procedure(s) to be triggered may be decided after deciding that a beam failure associated with the channel quality of a 2-TCI-state CORESETs (and/or the beam failure associated with channel quality of other related CORESET(s) corresponding to beam failure detection) is detected.

In 3GPP NR Rel-15/16, a BFR procedure may be configured to a UE in a per serving cell manner. When more than one TRP is provided to the UE, the TRPs may be intra-cell TRPs or maybe inter-cell TRPs. The TRP-specific BFR procedure may address a scenario where N>1 TRPs are configured in a same serving cell and among the N TRPs, M (TRPs are provided with the BFR procedures individually. The total number of TRPs configured to a UE may be more than N. The link quality between a UE and a TRP may be determined by performing measurements on a set of RSs. The set of RSs may be related to a hypothetical PDCCH channel quality. From the beam failure detection perspective, the set of RSs may be referred to as a BFD RS set. The set may be explicitly configured or implicitly derived from the activated TCI state(s) for the PDCCH monitoring. The TRP-specific BFR procedure may include at least one of the following features (a)-(c).

(a) More than one TCI state may be activated for receiving a CORESET. In some implementations, two TCI states may be activated for receiving a CORESET. In some implementations, the 2-TCI-state CORESET may be configured when at least one of the following conditions (a1) and (a2) is met. (a1) The UE is in a High-Speed Train (HST) scenario. In some implementations, the indication of a 2-TCI-state CORESET may implicitly indicate the HST scenario. (a2) The UE is in a Single Frequency Network (SFN) scenario. In some implementations, when the 2-TCI-state CORESET is signaled to the UE, all CORESETs may be activated with the 2 TCI states. That is, all CORESETs may be 2-TCI-state CORESETs. When the 2-TCI-state CORESET is signaled/configured to the UE in a (active) DL BWP in a serving cell, all CORESETs at least in the (active) DL BWP in the serving cell may be activated with the 2 TCI states. In some implementations, the UE may be provided with 2-TCI-state CORESET(s) and 1-TCI-state CORESET(s) at the same time. The 1-TCI-state CORESET may stand for a CORESET with one activated TCI state for reception. The UE may be provided with the 2-TCI-state CORESET(s) and the 1-TCI-state CORESET(s), where both of the CORESETs are associated with the monitored search space(s), in a (active) DL BWP in a serving cell.

(b) A UE may transmit a BFRQ indicating a beam failure detection of a TRP or a serving cell towards a gNB. The gNB may provide a response to indicate a successful reception of the BFRQ. After receiving the gNB reception, a new beam(s) q_new indicated by the UE in the BFRQ information may be applied to the PDCCH reception by the UE before further TCI state updated for the configured CORESETs.

In some implementations, only 2-TCI-State CORESET(s) related to the TRP or the serving cell may apply the new beam q_new. Only one TCI state of the 2-TCI-state CORESET(s) may be updated with the new beam q_new. Each of the two original TCI states of the 2-TCI-state CORESET(s) may correspond to a respective link of a corresponding TRP. The corresponding TRP for each of the two original TCI states may be different. The TCI state corresponding to the TRP with a failed link (the one with a beam failure detection) may be updated by the new beam q_new. The TCI state(s) with a default position/order in the 2-TCI-state CORESET(s) may be updated with the new beam q_new. In some implementations, the default position/order may be the first/last one of the two TCI states of the 2-TCI-state CORESET(s). The position or order of the TCI state for a CORESET may be observed or derived from a MAC CE for activating the TCI state(s) for receiving the CORESET. Both of the TCI states of the 2-TCI-state CORESET(s) may be updated with the new beam q_new. The new beam q_new may include two beams. When applying the new beam q_new, both of the two beams may be applied to the 2-TCI-state CORESET(s).

In some implementations, only 1-TCI-state CORESET(s) related to the TRP or the serving cell may apply the new beam q_new. Only 1-TCI-state CORESET(s) associated with a TRP the link of which is reported as a beam failure in BFRQ may be updated with the new beam q_new. All 1-TCI-state CORESET(s) of the serving cell containing the TRP the link of which is reported as a beam failure in BFRQ may be updated with the new beam q_new. All 1-TCI-state CORESET(s) associated with the TRP the link of which is reported as a beam failure in BFRQ may be updated with the new beam q_new.

In some implementations, both 2-TCI-state CORESET(s) and 1-TCI-state CORESET(s) related to the TRP or the serving cell may apply the new beam q_new. The new beam q_new may include two beams. When applying the new beam q_new, both of the two beams may be applied to the 2-TCI-state CORESET(s), and one of the two beams may be applied to the 1-TCI-state CORESET(s). When applying the new beam q_new for a 2-TCI-state CORESET, the 2-TCI-state CORESET may fall back to 1-TCI-state CORESET. After the fallback, there may be only one active TCI state, which is the new beam or reference signal index indicated by the q_new for the 2-TCI-state CORESET.

(c) A TCI state may be provided with information for identifying a cell and/or a TRP. The TCI state may be provided/associated with a cell index and/or a TRP index. For example, the physical cell index (PCI) and/or the parameter CORESETPoolIndex may be used as a cell index and a TRP index, respectively.

For multi-TRP based PDDCH reliability enhancement, a PDCCH may be monitored with multiple QCL assumptions (for reception), where individual QCL assumptions may be indicated by individual TCI states. For a beam failure detection purpose, the number of BFD RS may be limited (e.g., two BFD RSs per BWP) and the number of BFD RS may be smaller than or equal to the total number of TCI states for the PDCCH monitoring over all related CORESET(s). The related CORESETs may be the CORESETs configured for a determined active BWP. When the BFD RS is to be determined implicitly from the TCI states used for the PDCCH reception, a down selection on the TCI states may be needed. When an active TCI state for the PDCCH reception includes two reference signals, the UE may assume that one RS has a QCL-TypeD and the UE may use the QCL-TypeD RS as a BFD RS if the active TCI state is selected for the beam failure detection purpose. A 2-TCI-state CORESET may be activated with two TCI states for the PDCCH reception. Furthermore, for a TRP-specific BFR procedure, how to associate a detected beam failure with a set of BFR procedures may need to be determined, especially in an implicit BFD RS configuration case. For such a down selection, the following (a) and (b) may be considered.

(a) Individual sets of BFD RS(s) for individual BFR procedures may be decided. When BFD RS is not configured or is implicitly configured, and when a CORESET is provided with more than one activated TCI state, a rule for selecting/deciding the BFD RS for each TRP-specific BFR procedure corresponding to the 2-TCI-state CORESET may be applied.

(b) The TRP-specific BFR procedure(s) which should be triggered after deciding that beam failure associated with the channel quality of a 2-TCI-state CORESETs (and/or the beam failure associated with channel quality of other related CORESET(s) corresponding to beam failure detection) is detected.

In the following, the rules for the selection of a subset of RSs from the TCI states used for the PDCCH reception for beam failure detection purpose is described.

For a 2-TCI-state CORESET, the two active TCI states of the 2-TCI-state CORESET may be mapped to different sets of BFD RSs. Each of the different sets of the BFD RSs may correspond to different TRP-specific BFR procedures. Each of the TRP-specific BFR procedures may be applied for monitoring/recovering a link between the UE and a corresponding TRP. For a 1-TCI-state CORESET, the active TCI state of the 1-TCI-state CORESET may be mapped to a specific set of BFD RSs. Each of the BFD RS sets may correspond to different TRP-specific BFR procedures. Each of the TRP-specific BFR procedures may be applied for monitoring/recovering a link between the UE and a corresponding TRP. The specific set may be determined based on the cell or TRP information provided in the active TCI state. The specific set may be a default set. The default set may be a first/last set among all TRP-specific BFR procedures in a serving cell. The TRP-specific BFR procedures may not include a PRACH-based BFR procedure. The default set may be (pre-)configured or (pre-)specified.

The active TCI state(s) in CORESET(s) associated with the search space set with a shorter monitoring periodicity may be selected first. The active TCI state(s) in CORESET(s) associated with a higher priority CORESET(s) may be selected first. The higher priority CORESETs may be determined based on the CORESET index. The lower-indexed (or higher-indexed) CORESET may have a higher priority. The CORESET priority may be indicated via base station signaling. When considering/determining a CORESET priority, the UE may (only) consider the CORESET(s) that are associated with search space(s). The active TCI state(s) in CORESET(s) with a higher or lower CORESET group ID (e.g., CORESETPoolIndex) may be selected first. A master CORESET group may be identified by, e.g., a CORESET group ID, and the active TCI state(s) associated with the CORESET(s) in the master CORESET group may be selected first.

If there are multiple active TCI states in a CORESET, a default TCI state from the multiple active TCI states may be selected. The default TCI state may be preconfigured, or RRC configured, or pre-defined. The default TCI state may be determined, as specified, for example, in the 3GPP TS 38.213 and the 3GPP TS 38.214. For example, the default TCI state may be the first (or last) one among several active TCI states. The default TCI state may be the TCI state with the lowest (or highest) TCI-StateId among the active TCI states. A TCI state may be associated with a TCI state group index. The default TCI state may be the TCI state associated with the lowest (or highest) TCI state group index. In one implementation, each of the multiple active TCI states in the CORESET may be associated with a different TCI state group index.

A TCI state may be associated with a TCI state group index. The TCI state(s) used for the PDCCH reception and associated with a lower (or higher) TCI state group index may be selected first. Each of the multiple active TCI states in a CORESET may be associated with a different TCI state group index. An active TCI state the QCL RS(s) of which corresponds to a lower-indexed (or a higher-indexed) serving cell(s) may be selected first. An active TCI state the QCL RS(s) of which corresponds to an intra-band serving cell of the concerned serving cell may be selected first. The concerned serving cell may be the serving cell for which the beam failure detection is targeted, based on the selected BFD RS. An active TCI state with a lower (or a higher) TCI stat ID (e.g., TCI-StateId) may be selected first. An active TCI state with a shorter QCL RS(s) periodicity may be selected first. The active TCI states in CORESET(s) with multiple TCI states may be selected first (or last). The priority (e.g., the first or last priority) may be configured by a base station signaling. The priority may be “first” to benefit a multi-TRP case. The priority may be “last” to prioritize a single-TRP operation. The selection of a subset of RSs from the PDCCH reception of the TCI states for a beam failure detection purpose may be based on the UE implementation.

It should be noted that when the above rules are applied, it may be further subject to an order for applying a subset of rules. In the following, some implementations are described. It should be further noted that while these rules are assumed to apply for an implicit BFD RS selection, the same or different rules may also be applied for enhancing an implicit RLM RS selection.

Method #1: Two-Stage BFD RS Selection

In Stage-1, for a CORESET with multiple active TCI states (e.g., a 2-TCI-state CORESET), one active TCI state may be selected from the multiple active TCI states. In Stage-2, a required number of TCI states (which is equal to the number of BFD RSs to be derived) may be selected from the remaining active TCI states (individual remaining active TCI states correspond to individual CORESETs). It should be noted that the steps of the Stage-1 and Stage-2 may be applied for deriving a BFD RS set for a (TRP-specific) BFR procedure. In some implementations, the steps of the Stage-1 and Stage-2 may be applied iteratively for deriving other BFD RS sets for other (TRP-specific) BFR procedures. It should be noted that the remaining active TCI states may be TCI states that are selected in Stage-1.

Stage-1: For a CORESET with multiple active TCI states, one active TCI state for determining a BFD RS(s) (of a BFR procedure) may be selected. A default TCI state from the multiple active TCI states may be selected. The default TCI state may be preconfigured, or RRC configured, or pre-defined. The default TCI state may be determined, as specified, for example, in the 3GPP TS 38.213 and the 3GPP TS 38.214. For example, the default TCI state may be the first (or last) one of the multiple active TCI states. The default TCI state may be the TCI state with the lowest (or highest) TCI-StateId among the multiple active TCI states. The default TCI may be associated with a parameter CORESETPoolIndex of the CORESET. The parameter CORESETPoolIndex may be identified for the master CORESET, which may further correspond to a master TRP. A TCI state may be associated with a TCI state group index. The default TCI state may be the TCI state associated with the lowest (or highest) TCI state group index. Each of the multiple active TCI states in the CORESET may be associated with a different TCI state group index.

The Stage-1 may be performed for each one of the CORESET(s) with multiple active TCI states. The Stage-1 may not be performed on each one of the CORESET(s) with multiple active TCI states. The selection may be performed on the CORESET(s) one-by-one if the total number of active TCI states is larger than the required number of the BFD RSs. When the remaining number of TCI states (including those from multiple-TCI-State CORESET(s) and from 1-TCI-State CORESET(s)) is equal or smaller than the required number of BFD RSs, the selection may not be performed for the remaining multiple-TCI-State CORESET(s). The selection of multiple-TCI-State CORESET(s) for down-selecting corresponding to multiple TCI states may be based on the CORESET index. The multiple-TCI-States CORESET with the highest CORESET index may be selected for a down-selection first.

Stage-2: If the total number of active TCI states in related CORESET(s) is still larger than the number of required BFD RSs (e.g., the number is 2, as described in the 3GPP NR Rel-15/16), the remaining TCI states may be down-selected to meet the required number of BFD RSs. The remaining TCI states may originally correspond to multiple-TCI-State CORESETs or correspond to 1-TCI-State CORESET. The down-selection may be based on the UE implementation. The remaining TCI states originally corresponding to multiple-TCI-State CORESET may be down-selected first. The remaining TCI states originally corresponding to 1-TCI-State CORESET may be down-selected first. The Method #A selection rule when deriving an RS from the TCI states for the PDCCH receptions may be reused for the BFD RS derivation. The Method #A selection rule, with additional rule to prioritize a certain CORESET group index or TCI state group index may be used for BFD RS derivation. In some implementations, the UE may select the required number of RSs provided for active TCI states for PDCCH receptions in the CORESETs associated with the search space sets in an order from the shortest monitoring periodicity. If more than one CORESET is associated with search space sets having same monitoring periodicity, the UE may determine the order of the CORESETs (or TCI states) from, e.g., the highest CORESET group index (or TCI state group index). A master CORESET group may be identified by, e.g., a CORESET group ID, and then the active TCI state(s) associated with the master CORESET group may be selected first. If more than one CORESET (or TCI states) is associated with the same CORESET group index (or TCI state group index), the UE may determine the order of the CORESETs (or TCI states) from, e.g., the highest CORESET index (or TCI state index).

Method #2: Method #A-Based Rule

The Method #A selection rule when deriving an RS from the TCI states for the PDCCH receptions may be used as a baseline. On top of the Method #A selection rule, additional rules may be applied to take into account the fact that a CORESET may be activated with multiple TCI states. It should be noted that Method #2 may be applied for deriving a BFD RS set for a (TRP-specific) BFR procedure. In some implementations, Method #2 may be applied iteratively for deriving other BFD RS sets for other (TRP-specific) BFR procedures. If more TCI states than needed remain after applying the Method #A rule, the TCI states with the lower (or higher) TCI state index may be selected. If more TCI states than needed remain after applying the Method #A rules, the TCI states corresponding to an intra-band serving cell of the concerned serving cell may be selected first. The concerned serving cell may be the serving cell for which a beam failure detection is targeted, based on the selected BFD RS. If still more TCI states than needed remain after applying the Method #A rule, the TCI states with a lower (or higher) TCI state index may be selected.

Method #3: Prioritizing CORESETs with Multiple TCI States

The TCI states associated with CORESET(s) with multiple TCI states may be selected with a (higher) priority. If the resultant number of TCI states is larger than the required number, additional rules, such as Method #1 to Method #4 provided in the present disclosure, may be applied for the down selection. If the resultant number of TCI states is smaller than the required number, the TCI states associated with 1-TCI-State CORESET(s) may be selected gradually also based on the rules, e.g., Method #1 to Method #4 rules provided in the present disclosure. It should be noted that Method #3 may be applied for deriving a BFD RS set for a (TRP-specific) BFR procedure. In some implementations, Method #3 may be applied iteratively for deriving other BFD RS sets for other (TRP-specific) BFR procedures. The TCI states associated with the CORESET(s) with multiple TCI states may be selected. If the resultant number of TCI states is larger than the required number, a subset of the resultant TCI states, as described above, may be excluded so that the remaining number of TCI states meets the requirement. The exclusion principle may be based on the UE implementation. The exclusion principle may be based on Method #2. If the resultant number of TCI states is smaller than the required number, additional TCI state(s) associated with the CORESET(s) with 1 TCI state may be selected until a total number of selected TCI states meets the requirement. The selection may be based on the UE implementation. The selection may be based on the Method #A selection rule. The selection may be limited to selecting 1-TCI-state CORESET(s) for the BFD RSs. The selection may be limited to selecting 2-TCI-state CORESET(s) for the BFD RSs.

Method #4: Prioritizing CORESET(s) with 1 TCI State

The TCI states associated with the CORESET(s) with 1 TCI states may be selected with a (higher) priority. If the resultant number of TCI states is larger than the required number, additional rules, such as Method #1 to Method #4 rules provided in the present disclosure, may be applied for the down selection. If the resultant number of TCI states is smaller than the required number, the TCI states associated with multiple-TCI-State CORESET(s) may be selected gradually based on the rules, e.g., Method #1 to Method #4 rules provided in the present disclosure, until the total number of TCI states meets a required number. It should be noted that Method #4 may be applied for deriving a BFD RS set for a (TRP-specific) BFR procedure. In some implementations, Method #4 may be applied iteratively for deriving other BFD RS seta for other (TRP-specific) BFR procedures. The TCI states associated with the CORESET(s) with one TCI state may be selected. If the resultant number of TCI states is larger than the required number, a subset of the resultant TCI states may be excluded, such that the remaining number of TCI states meets a required number. The exclusion principle may be based on the UE implementation. The exclusion principle may be based on the Method #A selection rule. If the resultant number of TCI states is smaller than the required number, additional TCI state(s) associated with the CORESET(s) with multiple TCI states may be selected until a total number of selected TCI states meets the requirement. The selection may be based on the UE implementation. The selection may be based on Method #2.

For a TRP-specific BFR procedure, how to associate a detected beam failure with a set of BFR procedures may need to be determined, especially in an implicit BFD RS configuration case. In some implementations, which TRP-specific BFR procedure(s) to trigger may need to be determined after deciding that beam failure associated with the channel quality of 2-TCI-state CORESET(s) (and/or the beam failure associated with channel quality of other related CORESET(s) corresponding to beam failure detection) is detected. In this situation, a PDCCH channel quality associated with a CORESET may be jointly determined based on all of its activated TCI states, irrespective of the fact that a CORESET may be activated with multiple TCI states and thus, may be associated with multiple TRPs.

For an active BWP, a UE may be configured with one or more CORESET(s). The CORESET(s) may include only a 2-TCI-state CORESET, or may include both the 1-TCI-state CORESET and the 2-TCI-state CORESET.

For detection of a beam failure, the activated TCI states of the CORESET(s) associated with an active BWP may be used. The RS(s) from the activated TCI states may be used for the beam failure detection. The QCL-typeD RS(s) from the activated TCI states may be used for beam the failure detection. In a case that there is a threshold number of (BFD) RSs to be used for beam the failure detection, the down-selection from the RS(s) from the activated TCI states of the CORESET(s) may be needed. The resolution for selecting the RS(s) from the activated TCI states may be the CORESET. That is, all QCL-typeD RS(s) of a CORESET may be selected as the BFD RS(s) when the CORESET is selected as a performance metric for the beam failure detection. The CORESET may be considered as failed if both hypothetic block error rate (BLER) derived based on all QCL-typeD RS(s) is higher than a threshold value. The CORESET may be considered as failed if both hypothetic BLER derived based on all QCL-typeD RS(s) is higher than one or more threshold values, where each of the QCL-typeD RS may be compared against a different threshold value. Methods provided in the present disclosure, e.g., Method #1 to Method #4, may be applied, at least for determining the (QCL-typeD) RS(s) as BFD RS(s) for a beam failure detection. If all (QCL-typeD) RS(s) associated with the selected CORESET(s) indicate that their individual PDCCH channel qualities are lower than a threshold (e.g., the BLER value is higher than a threshold value), a beam failure may be considered to have been detected for the active BWP.

More than one BFR procedure may be configured for the determined BFD RS(s). For example, two BFR procedures may be associated with the determined BFD RS(s). The determined BFD RS(s) may constitute a BFD RS set. After detection of a beam failure, only one of the BFR procedures may be declared as to have had beam failure and its subsequent steps may be triggered for the beam failure recovery. The declared BFR procedure may be (pre-)specified/(pre-)configured. The declared BFR procedure may be determined based on the first/last activated TCI state of a 2-TCI-state CORESET. The TCI state may provide identity information related to a cell or a TRP. A BFR associated with the cell/TRP index of the first/last activated TCI state may be selected. The 2-TCI-state CORESET may be selected based on a CORESET priority as described in the present disclosure. The 2-TCI-state CORESET may be any one of the 2-TCI-state CORESET(s) and thus, may depend on the UE implementation. In some implementations, using any of the 2-TCI-state CORESET(s) for the BFR procedure selection may provide the same result. The selection of the BFR procedures may be based on the UE's Doppler/mobility information. A BFR procedure associated with a cell/TRP with its Doppler/mobility information showing the UE is, e.g., approaching the cell/TRP, may be selected.

Only one BFR procedure may be configured for the determined BFR RS(s). Subsequent BFRQ information may be transmitted to the gNB by either the MAC CE or by the configured UL resources of the BFR procedure. A new beam q_new information carried in the BFRQ information may be determined from a set of candidate RSs/beams provided in the BFR procedure configuration. The candidate RSs/beams may be associated with different cells/TRPs. The TCI state may provide identity information related to a cell or a TRP. The new beam q_new may be selected from the subset of candidate RSs/beams that is associated with the cell/TRP of the first/last activated TCI state of a 2-TCI-state CORESET. The 2-TCI-state CORESET may be selected based on a CORESET priority, as described in the present disclosure. The 2-TCI-state CORESET may be any one of the 2-TCI-state CORESET(s) and thus, may depend on the UE implementation. In some implementations, using any of the 2-TCI-state CORESET(s) for the BFR procedure selection may provide the same result. A cell/TRP may be selected based on the UE's Doppler/mobility information. The new beam q_new may be selected from the subset of candidate RSs/beams that is associated with the selected cell/TRP.

In some implementations, the methods provided in the present disclosure may be applied to a CORESET or at least a DL channel, which is indicated/activated to receive more than one TCI state (or QCL assumption). It may imply that a CORESET with 3 TCI states may be applicable.

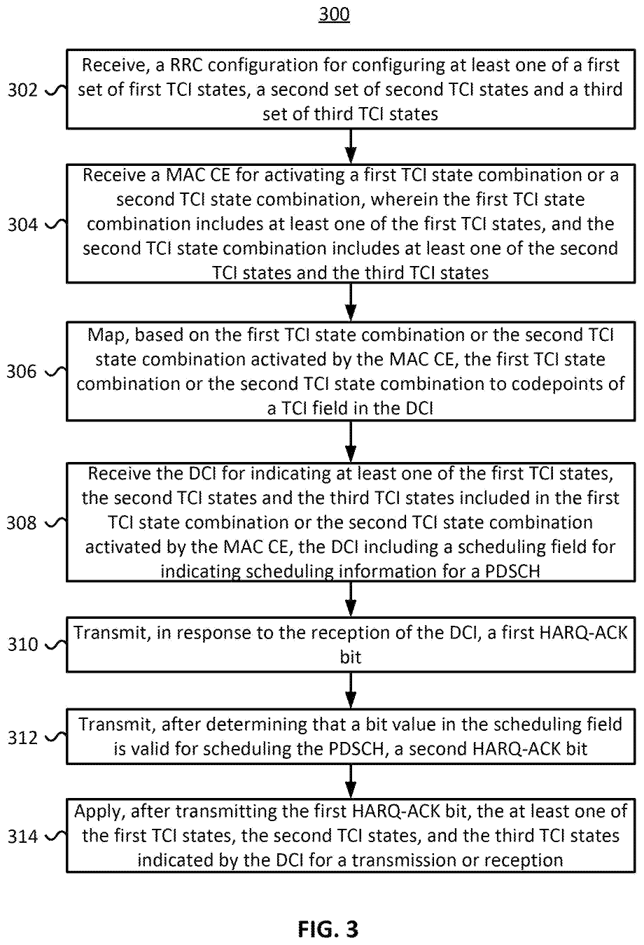

FIG. 3 is a flowchart illustrating a method 300 performed by a UE for a beam operation, according to an example implementation of the present disclosure. Although actions 302, 304, 306, 308, 310, 312 and 314 are illustrated as separate actions represented as independent blocks in FIG. 3, these separately illustrated actions should not be construed as necessarily order dependent. The order in which the actions are performed in FIG. 3 is not intended to be construed as a limitation, and any number of the disclosed blocks may be combined in any order to implement the method, or an alternative method. Moreover, each of actions 302, 304, 306, 308, 310, 312 and 314 may be performed independent of other actions and may be omitted in some implementations of the present disclosure.

In action 302, the UE may receive, a radio resource control (RRC) configuration for configuring at least one of a first set of first Transmission Configuration Indication (TCI) states, a second set of second TCI states and a third set of third TCI states. The first TCI states may be referred to as joint TCI states. The second TCI states may be referred to as uplink (UL)-only TCI states. The third TCI states may be referred to as downlink (DL)-only TCI states.

In action 304, the UE may receive a medium access control (MAC) control element (CE) for activating a first TCI state combination or a second TCI state combination. The first TCI state combination may include at least one of the first TCI states, and the second TCI state combination may include at least one of the second TCI states and the third TCI states. That is, the first TCI state combination may include at least one first TCI state. The second TCI state combination may include at least one second TCI state. The second TCI state combination may include at least one third TCI state. The second TCI state combination may include at least one second TCI state and at least one third TCI state.

In action 306, the UE may map, based on the first TCI state combination or the second TCI state combination activated by the MAC CE, the first TCI state combination or the second TCI state combination to codepoints of a TCI field in the downlink control information (DCI).

In action 308, the UE may receive the DCI for indicating the at least one of the first TCI states, the second TCI states, and the third TCI states included in the first TCI state combination or the second TCI state combination activated by the MAC CE. That is, if the first TCI state combination is activated by the MAC CE, the DCI may indicate the at least one first TCI state included in the first TCI state combination which is activated by the MAC CE. If the second TCI state combination is activated by the MAC CE and the second TCI state combination includes the at least one second TCI state, and the DCI may indicate the at least one second TCI state included in the second TCI state combination which is activated by the MAC CE. If the second TCI state combination is activated by the MAC CE and the second TCI state combination includes the at least one third TCI state, the DCI may indicate the at least one third TCI state included in the second TCI state combination which is activated by the MAC CE. If the second TCI state combination is activated by the MAC CE and the second TCI state combination includes the at least one second TCI state and the at least one third TCI state, the DCI may indicate the at least one second TCI state and the at least one third TCI state included in the second TCI state combination which is activated by the MAC CE. The DCI may include a scheduling field for indicating scheduling information for a physical downlink shared channel (PDSCH). In some implementations, each bit in at least one field in the DCI is set to “0” or “1”, and the at least one field may be different from the TCI field and the scheduling field. That is, the at least one filed other than the TCI field and the scheduling field in the DCI may be set to a specific value, and the specific value may be one of all 0's or all l's.

In action 310, the UE may transmit, in response to the reception of the DCI, a first Hybrid Automatic Repeat Request-Acknowledgement (HARQ-ACK) bit.

In action 312, the UE may transmit, after determining that a bit value in the scheduling field is valid for scheduling the PDSCH, a second HARQ-ACK bit. In some implementations, the bit value in the scheduling field may be invalid for scheduling the PDSCH.

In action 314, the UE may apply, after transmitting the first HARQ-ACK bit, the at least one of the first TCI states, the second TCI states, and the third TCI states indicated by the DCI for a transmission or reception. In some implementations, the UE may apply, after determining that the DCI format indicates the first TCI states, receiver (RX) parameters for receiving one or more configured downlink (DL) transmissions and transmitter (TX) parameters for transmitting one or more configured uplink (UL) transmissions, and the first TCI states may include the RX parameters and the TX parameters. In some implementations, the UE may apply, after determining that the DCI format indicates the second TCI states, the transmitter (TX) parameters for transmitting one or more configured uplink (UL) transmissions, and the second TCI states may include the TX parameters. In some implementations, the UE may apply, after determining the DCI format indicates the third TCI states, the receiver (RX) parameters for receiving one or more configured downlink (DL) transmissions, and the third TCI states may include the RX parameters.

In the present disclosure, several methods for enabling a common beam indication and its acknowledgement are provided. Details on a beam indication format, as well as an acknowledgement mechanism/format are provided. The methods provided in the present disclosure include modifying the DCI formats with various purposes for a common beam indication purpose. The methods provided in the present disclosure consider adding extra HARQ-ACK bits and a new/modified MAC CE for confirming a successful reception of the common beam indication. The methods provided in the present disclosure consider both joint DL/UL common beam indication and separate DL/UL common beam indication, as well as the impact the number of TRPs may cause.

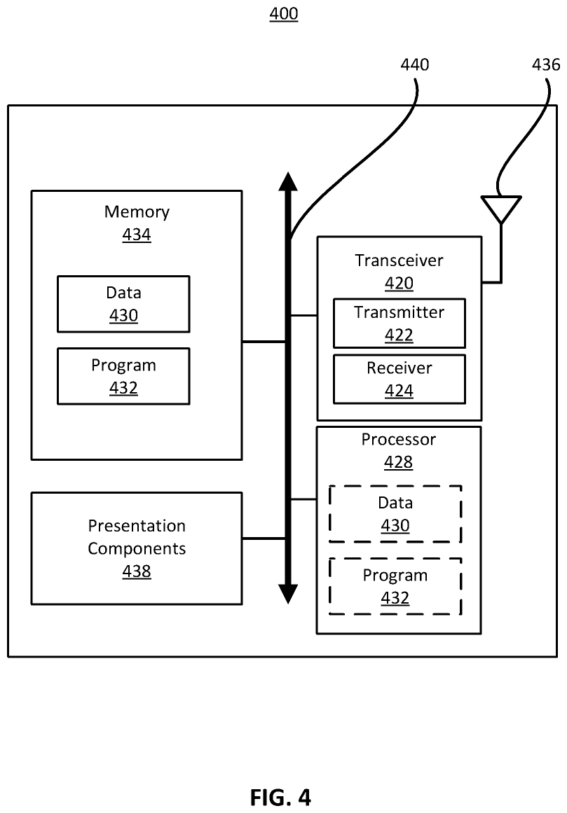

FIG. 4 is a block diagram illustrating a node 400 for wireless communication, according to an example implementation of the present disclosure. As illustrated in FIG. 4, a node 400 may include a transceiver 420, a processor 428, a memory 434, one or more presentation components 438, and at least one antenna 436. The node 400 may also include a radio frequency (RF) spectrum band module, a BS communications module, a network communications module, a system communications management module, Input/Output (I/O) ports, I/O components, and a power supply (not illustrated in FIG. 4).

Each of the components may directly or indirectly communicate with each other over one or more buses 440. The node 400 may be a UE or a BS that performs various functions disclosed with reference to FIG. 3.

The transceiver 420 has a transmitter 422 (e.g., transmitting/transmission circuitry) and a receiver 424 (e.g., receiving/reception circuitry) and may be configured to transmit and/or receive time and/or frequency resource partitioning information. The transceiver 420 may be configured to transmit in different types of subframes and slots including but not limited to usable, non-usable and flexibly usable subframes and slot formats. The transceiver 420 may be configured to receive data and control channels.

The node 400 may include a variety of computer-readable media. Computer-readable media may be any available media that may be accessed by the node 400 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules or other data in a modulated data signal such as a carrier wave or other transport mechanisms and include any information delivery media.

The term “modulated data signal” may mean a signal that has one or more of its characteristics set or changed in such a manner as to encode information in the signal. Communication media may include wired media such as a wired network or direct-wired connection, and wireless media such as acoustic, RF, infrared and other wireless media. Combinations of any of the previously listed components may also be included within the scope of computer-readable media.

The memory 434 may include computer-storage media in the form of volatile and/or non-volatile memory. The memory 434 may be removable, non-removable, or a combination thereof. Example memory may include solid-state memory, hard drives, optical-disc drives, etc. As illustrated in FIG. 4, the memory 434 may store a computer-readable and/or computer-executable program 432 (e.g., software codes) that are configured to, when executed, cause the processor 428 to perform various functions disclosed herein, for example, with reference to FIG. 3. Alternatively, the program 432 may not be directly executable by the processor 428 but may be configured to cause the node 400 (e.g., when compiled and executed) to perform various functions disclosed herein.

The processor 428 (e.g., having processing circuitry) may include an intelligent hardware device, e.g., a Central Processing Unit (CPU), a microcontroller, an ASIC, etc. The processor 428 may include memory. The processor 428 may process the data 430 and the program 432 received from the memory 434, and information transmitted and received via the transceiver 420, the base band communications module, and/or the network communications module. The processor 428 may also process information to send to the transceiver 420 for transmission via the antenna 436 to the network communications module for transmission to a CN.

One or more presentation components 438 may present data indications to a person or another device. Examples of presentation components 438 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

1-10. (canceled)

11. A method performed by a user equipment (UE) for a beam operation, the method comprising:
receiving, from a base station (BS), a radio resource control (RRC) configuration for configuring a set of joint transmission configuration indication (TCI) states;
receiving, from the BS, a medium access control (MAC) control element (CE) for activating a subset of joint TCI states in the set of joint TCI states, wherein the MAC CE is used to map the subset of joint TCI states to codepoints of a TCI field in downlink control information (DCI);
receiving, from the BS, the DCI indicating a joint TCI state included in the subset of joint TCI states activated by the MAC CE;
determining whether the DCI includes a downlink (DL) assignment;
transmitting, in response to reception of the DCI, first hybrid automatic repeat request-acknowledgement (HARQ-ACK) information in a case that the DCI does not include the DL assignment; and
transmitting, in response to the reception of the DCI and reception of a physical downlink shared channel (PDSCH), second HARQ-ACK information in a case that the DCI includes the DL assignment.

12. The method of claim 11, wherein in a case that the DCI does not include the DL assignment, a bit value corresponding to a redundancy version (RV) field included in the DCI is set to a specific value.

13. The method of claim 11, wherein in a case that the DCI does not include the DL assignment, a bit value corresponding to a modulation and coding scheme (MCS) field included in the DCI is set to a specific value.

14. The method of claim 11, wherein in a case that the DCI does not include the DL assignment, a bit value corresponding to the frequency domain resource assignment (FDRA) field is set to a specific value.

15. A user equipment (UE) for a beam operation, the UE comprising:
one or more processors; and
at least one memory coupled to the one or more processors, wherein the at least one memory stores one or more computer-executable—instructions that, when executed by the one or more processors, cause the UE to:
receive, from a base station (BS), a radio resource control (RRC) configuration for configuring a set of joint transmission configuration indication (TCI) states;
receive, from the BS, a medium access control (MAC) control element (CE) for activating a subset of joint TCI states in the set of joint TCI states, wherein the MAC CE is used to map the subset of joint TCI states to codepoints of a TCI field in downlink control information (DCI);
receive, from the BS, the DCI indicating a joint TCI state included in the subset of joint TCI states activated by the MAC CE;
determine whether the DCI includes a downlink (DL) assignment;
transmit, in response to reception of the DCI, first hybrid automatic repeat request-acknowledgement (HARQ-ACK) information in a case that the DCI does not include the DL assignment; and
transmit, in response to the reception of the DCI and reception of a physical downlink shared channel (PDSCH), second HARQ-ACK information in a case that the DCI includes the DL assignment.

16. The UE of claim 15, wherein in a case that the DCI does not include the DL assignment, a bit value corresponding to a redundancy version (RV) field included in the DCI is set to a specific value.

17. The UE of claim 15, wherein in a case that the DCI does not include the DL assignment, a bit value corresponding to a modulation and coding scheme (MCS) field included in the DCI is set to a specific value.

18. The UE of claim 15, wherein in a case that the DCI does not include the DL assignment, a bit value corresponding to the frequency domain resource assignment (FDRA) field is set to a specific value.

19. A base station (BS) for a beam operation, the BS comprising:
one or more processors; and
at least one memory coupled to the one or more processors, wherein the at least one memory stores one or more computer-executable—instructions that, when executed by the one or more processors, cause the BS to:
transmit, to a user equipment (UE), a radio resource control (RRC) configuration for configuring a set of joint transmission configuration indication (TCI) states;
transmit, to the UE, a medium access control (MAC) control element (CE) for activating a subset of joint TCI states in the set of joint TCI states, wherein the MAC CE is used to map the subset of joint TCI states to codepoints of a TCI field in downlink control information (DCI);
transmit, to the UE, the DCI indicating a joint TCI state included in the subset of joint TCI states activated by the MAC CE;
receive, in response to transmission of the DCI, first hybrid automatic repeat request-acknowledgement (HARQ-ACK) information in a case that the DCI does not include the DL assignment; and
receive, in response to the transmission of the DCI and transmission of a physical downlink shared channel (PDSCH), second HARQ-ACK information in a case that the DCI comprises the DL assignment.
